(19) United States
(12) Patent Application Publication
(10) Pub. No.: US 2023/0394415 A1
(43) Pub. Date: Dec. 7, 2023

(54) Remote Collaboration Platform For Non-Destructive Evaluation

(71) Applicant: Ooga Technologies, Inc., Cary, NC (US)

(72) Inventors: Ajay Pasupuleti, Apex, NC (US); Igor Kasovski, Rochester, NY (US); Michael L. Turnbow, Signal Mountain, TN (US); Dale Lynn, Genesee, ID (US)

(21) Appl. No.: 18/327,816

(22) Filed: Jun. 1, 2023

Related U.S. Application Data
(60) Provisional application No. 63/348,021, filed on Jun. 2, 2022.

(51) Int. Cl. G06Q 10/0639

(52) U.S. Cl. CPC G06Q 10/06393; G06Q 10/06398

(57) ABSTRACT

Systems and methods for Non-Destructive Evaluation (NDE) are described. The NDE system comprises of a platform with inspection, audit and simulator modules running on a cloud-based server. The platform facilitates non-destructive evaluation of objects or parts for manufacturing defects by industry experts. The platform connects project owners and experts for NDE over a secure communication channel. Experts are qualified by the system. The system provides for training on different scan methods using a simulator.

### CROSS-REFERENCE TO RELATED APPLICATIONS

Under 35 USC 119(e), this application claims the benefit of U.S. Provisional Application No. 63/348,021 filed Jun. 2, 2022, which is hereby incorporated by reference in its entirety.

### FIELD OF EMBODIMENTS

The described embodiments relate generally to non-destructive inspection of apparatus. More particularly, the described embodiments relate to systems and methods for remote inspection of apparatus.

### BACKGROUND

Non-destructive Evaluation (NDE) is used for evaluation of defects or flaws or characteristics of material, components, and/or systems without causing damage or altering the tested item. Non-destructive evaluation does not permanently alter the article being inspected; hence it is a highly valuable technique, allowing for savings in cost and/or time when used for product evaluation, troubleshooting, and research. Frequently used non-destructive evaluation methods include magnetic-particle inspections, eddy-current testing, liquid (or dye) penetrant inspection, radiographic inspection, ultrasonic testing, and visual testing. Non-destructive evaluation (NDE) is commonly used in such fields as mechanical engineering, petroleum engineering, electrical engineering, systems engineering, aeronautical engineering, medicine, art, and the like.

NDE requires access to experts as needed with the appropriate talent to address specific and/or unexpected challenges. The experts need to be available on site and as the need arises. There is a growing need for on-demand experts in NDE and reliable analysis of NDE data remotely.

### SUMMARY

This disclosure is directed to methods and systems for non-destructive remote evaluation. In one embodiment, a method for enabling remotely located expert to perform non-destructive evaluation (NDE) comprises of receiving project data from a project owner, the project data comprising digital data for non-destructive evaluation (NDE) acquired by non-destructive means. The methods provides the project owner a selection of experts from a database of experts, the expert indicates availability to evaluate the project. Project data in then provided to the selected expert by establishing a secure communication between the expert and the project owner for exchange of information. Utility software is provided to the expert for non-destructive evaluation. Non-destructive evaluation results of the project are received from the expert which is then transmitted to the project owner via the secure communication channel. In some embodiments, the experts are selected by artificial intelligence techniques based on any of qualification, experience, availability, and recommendations. In other embodiments, the experts from the database of experts submit bids for the non-destructive evaluation of the project. In some embodiments, the expert is evaluated before enrolling in the database. The expert from the database of experts is trained on a anyone of simulator or remote means. Performance of the expert is compared against a database of performance of other experts. The digital data received by the expert can be anyone of material type, thresholds for flaw, test type, description of an object for evaluation and image of the object. The evaluation results comprise anyone of flaws, thresholds exceeded, and annotated image data. In some embodiments, software developed by machine learning techniques provide assistance to the expert. Yet, in other embodiments, artificial intelligence software is the expert.

In some embodiments, a method of expert evaluation workflow is disclosures. The method comprises of receiving by an expert, an alert about availability of a project for non-destructive evaluation (NDE) from a NDE platform; receiving by the expert, project details in digital format; sending by the expert, to the NDE platform accepting the project; providing by the NDE platform, utility software for non-destructive evaluation of the project; receiving by the NDE platform, non-destructive evaluation results from the expert. The method of expert evaluation further comprises evaluating the expert before adding to a database in the NDE platform; the expert is trained on any one of a simulator or remote means.

The system comprises a first user device and a second user device configured to communicate with a cloud-based server, the first user device is configured to acquire digital information associated with an object for DE; wherein an inspection module running on the cloud-based server is configured to enable non-destructive inspection of the object utilizing the digital information, wherein the first user device is configured to receive a report of the non-destructive inspection acquired by a second user device. In some embodiments, user of a second device is a qualified non-destructive evaluation expert. The inspection module further comprises software developed through machine learning techniques. A training module of the system runs on the cloud-based server, configured to provide training for the non-destructive inspection. In some embodiments, a simulator s provided for hands-on training for the non-destructive inspection. The system further comprises an audit module configured to facilitate monitoring of the non-destructive inspection in some embodiments and facilitate audit of the digital information in other embodiments.

The system for training NDE comprises a sensor configured to acquire digital data associated with a scan of a specimen; control software for transmitting the digital data from the sensor to a display device; communication software configured to select a flaw for simulation; visualization software configured to display the image data. The system further comprises acquiring by the control software, a specification of the specimen based on a RFID tag connected to the specimen. The control software is further configured to virtually impose image of the flaw on the digital data. The system facilitates positioning the flaw in random locations or randomly changing the nature of the flaw. The sensor can comprise any one of Electromagnetic Tracking System (ETS) sensor, camera, ultrasonic sensor and magnetic sensor. The sensor is connected to probe for scanning. The control software is configured to compute position of the sensor by tracking motion of the probe in three-dimensional space with six-degrees of freedom.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 shows a schematic block diagram of a system of non-destructive remote collaboration platform architecture.

FIG. 2 shows a block diagram of NDE platform.

FIG. 3 shows a workflow on NDE platform for evaluations.

FIG. 4 shows a block diagram of an NDE simulator.

FIG. 5 shows a flowchart of NDE training.

### DETAILED DESCRIPTION

The described embodiments are embodied in methods, apparatuses, and systems for non-destructive remote evaluation. Various implementations in accordance with the present disclosure are directed to providing enhanced and optimized non-destructive evaluation (NDE), particularly by implementing and operating non-destructive evaluation-based platform and simulator for training to use NDE systems.

Data Management is a growing issue in NDE including the need to readily access experts as needed with the appropriate talent to address specific and/or unexpected challenges. Non-Destructive Evaluation (NDE) system addresses the issues of providing access to experts and training of managing the experts. For example, applications of NDE such as phased array, digital radiography, and computed tomography create files upwards to over 50 gigabytes per part. Ability to find certified technicians on-demand for immediate assessment is challenging. The certification process in many industries, including oil/gas, aerospace, and defense require numerous years for On-the Job Training (OJT), and On-the Job Experience (OJE). The demand for Level 2's and 3's skilled experts to complete regulated tasks are extremely high. Production sites where large amounts of evaluations are required create risk to overall part inspection lead time.

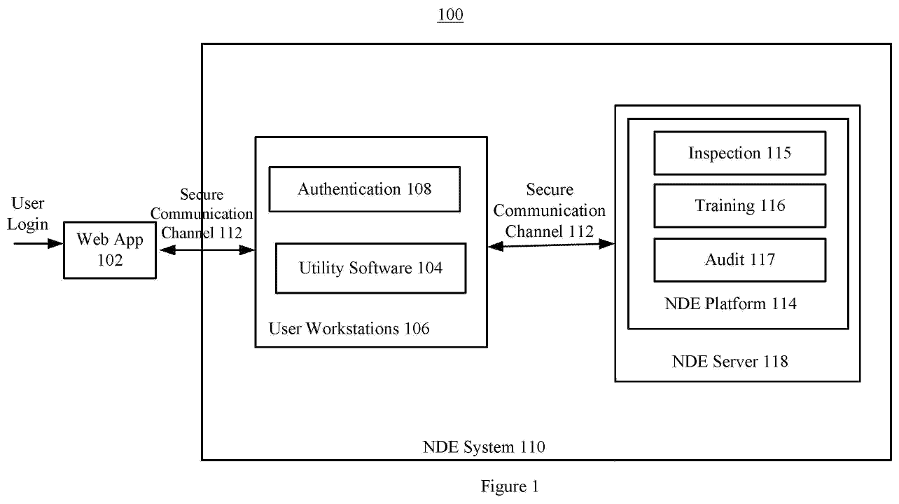

FIG. 1 shows a system of Non-Destructive Evaluation (NDE) system architecture in an example 100. NDE system architecture 100 provides efficient data management, storage, retrieval and sharing abilities. NDE system architecture 100 also referred to as system enables to complete evaluation or inspection automatically with digital systems, digital twins, artificial intelligence, and automated defect recognition, with final decisions provided by a skilled and qualified expert. The system allows a selective group or multiple parties to review singularly or collectively its data, facilitating collaboration and discussion concerning challenging technical or non-technical issues.

Systems and methods are provided for NDE professionals for efficient management of communication and data, remote inspection, training, certification, and team management. NDE platform is secure, fast, and scalable. The NDE system architecture 100 is a serverless architecture based on existing, established, and proven cloud infrastructure.

NDE system 110 comprises of plurality of user workstation 106 and NDE server 118. NDE server 118 is a cloud-based server providing secure access to NDE platform 114. NDE system 110 makes it possible for experts to be readily accessible globally to address questions and assist in effective and efficient resolution of issues. Specifically, the provisions include secure data storage, associated software necessary for viewing and analysis, secured platform for private viewing and highly qualified, certified, and experienced personnel who can address NDE issues.

In the described embodiments, project owner refers to one who has a job or a project which requires non-destructive evaluation. NDE expert or expert or consultant refers to a skilled and qualified personnel who can inspect an object and complete an evaluation. In the described embodiments non-destructive evaluation (NDE) and non-destructive inspection (NDI) are used interchangeably.

The NDE system 110 enables remote inspection of parts or systems in use or in manufacture. NDE system can be deployed in any industry where inspection of parts or systems for defects require access to parts. Failure analysis or manufacturing defects are some of the common evaluations that are requested in the system. Oil/gas, aerospace, automotive, and defense are some of the example industries where NDE system can be deployed.

In order to have a reliable remote inspection process, system allows users to create accounts and multiple account types. NDE server 118 access will be controlled based on account type. NDE platform 114 enables to bill users and receive payments. The platform allows users to create and access inspection events. The platform tracks usage of the various software. Multi-part uploads of large documents help in reducing upload times. A searchable database of experts and/or consultants are provided for all projects. Communication channels are made available for consultants and/or project owners. Cloud servers and access to server is transparent to users. Project owners have access to project owner dashboard after a project is created. The user account type determines access to resources. Available resources are displayed on dashboard.

System 100 comprises NDE system 110. Users login to User workstations 106 using web application 102. Authentication 108 authenticates users and enable access to cloud based NDE server 118 and user workstations 106 by establishing secure communication channel 112. NDE server 118 comprises of secure data lake. Traffic control systems such as SQS queue can be employed to manage the queue. Secure data lake can comprise of a plurality of Simple Storage Service S3 buckets, enabling safe storage and retrieval of files. User workstations 106 are configurable remote project workstations comprising plurality of end-user workstations with instances of various utility software 104. User VPN authentication and user privilege management is executed in the authentication system 108.

NDE server 118 comprises NDE Platform 114. NDE platform 114 comprises of Inspection module 115, Training module 116 and Audit module 117. NDE platform 114 provides access to project owners and consultants for NDE inspection, training and audit. Project owners and consultants/experts communicate over a secure communication channel 112. Each project has its own access controls and communication channel there by providing a secure environment. Experts/consultants receive project description and project related information from the field related to a failed part over the secure communication channel 112 provided by the project owner. Project description and related information includes material type, industry, size of the object, acceptable thresholds, digital data generated from a plurality of scans of the object acquired by non-destructive means. A defect is an object indicates that the object has crossed the threshold of acceptable limits. A defect is detectable only of the object has a minimum detectable size. Cracks in object, brazed joints, porosity, surface roughness, under-cut in welding, are some of the common defects which are analyzed. Pipes and machine parts are some examples of objects for inspection.

Inspection report including expert analysis of defects in objects, and solutions are reported back to the project owner on the NDE platform 114 over the secure communication channel 112. Inspection report includes written report listing type of inspection, type and size of digital data, detailed measurement of various parameters, such as location, size, acceptable thresholds, type of inspection. Some reports include annotated digital data of inspected object.

Utility software 104 can comprise software for receiving information from the field related to a failed part, viewing and analysis of defects, comparing against a database of defects and possible solutions. Utility software can be provided by NDE platform 114 in some embodiments, while project owner may have to provide access to utility software in certain other cases. The project owner defines data access controls.

NDE platform 114 provides access to users to various Machine Learning (ML) programs (including proprietary and nonproprietary programs). The platform guides users through various stages of the ML implementation by providing workflow and application recommendations. The machine learning programs assist the NDE experts with automated defect recognition and further provide tools for predictive maintenance. Machine learning techniques can be further employed to detect known flaws there by reducing dependency on experts. On-the clock availability of inspection is great benefit to project owners. In some embodiments, the expert in a software enabled by artificial intelligence techniques.

NDE platform 114 provides access to inspection training and audit. Project owners login to inspection module 115 to create project, input project details, interact with experts and collect inspection results. Experts login to inspection module 115 to select projects for inspection, interact with project owners and report inspection results. NDE platform 114 provides training to experts. Training module 116 is integrated into NDE platform 114 for classroom training, AR/VR enabled training and simulator training. Training is aimed primarily to lower the failure rate of NDE professionals when inspecting for flaws. Access to known flaws is limited and/or extremely expensive to many NDT professionals The simulator has a database of known flaws. Trainee 206 can practice and improve flaw detection skills for various flaws in a close to real world environment. Examiner or supervisor 208 can monitor trainee activities and provide additional training. Audit module 117 enables auditing experts and project owners. Expert auditor 210 is an auditor who audits experts to ensure quality inspections. Project owner auditor 212 audits project owners to ensure adequate data and scan techniques are employed for consistent results.

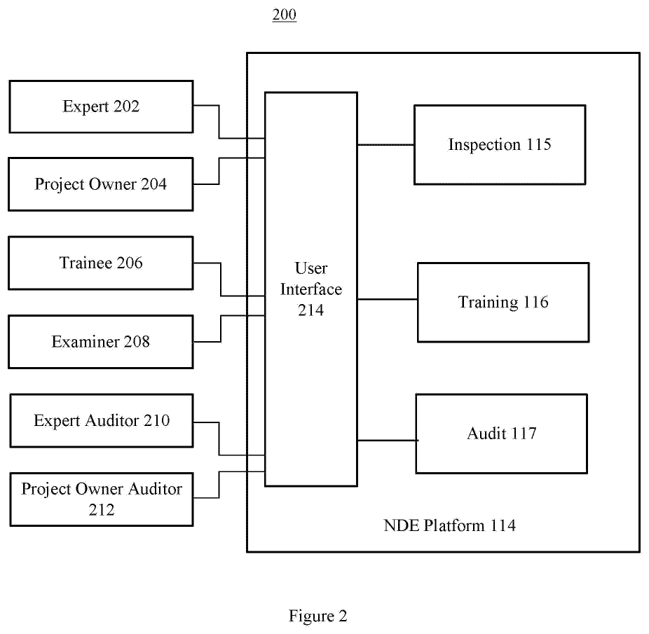

FIG. 2 describes the various modules and the operation of the modules of the NDE platform 114. Inspection module 115, training module 116 and audit module 117 are closely integrated with each other. User interface 214 connects inspection module 115, training module 116 and audit module 117 to expert 202, project owner 204, trainee 206, examiner 208, expert auditor 210 and project owner auditor 212. User interface 214 provides a dashboard to each of expert 202, project owner 204, trainee 206, examiner 208, expert auditor 210 and project owner auditor 212 for managing account, profile, and projects.

Users of all the three modules are authenticated by authentication 108. Inspection module 115 facilities NDE. Inspection module can be accessed by expert for NDE. Project owner input request for NDE and receives an evaluation report. Expert reads in NDE request, performs evaluation and enters the evaluation results in inspection module 115. Trainee 206 and examiner 208 can access training module 116. Experts are training in training 116 before enrolling in expert database. Training can be classroom and remote training or simulator based hands-on training. Examiner 208 can be supervisor during training. Examiner 208 can remotely monitor a trainee 206 learning on a simulator and provide feedback.

Audit module 117 oversees inspection module 115 for compliance and quality. Experts 202 are audited for performance and compared with the industry and ranked by expert auditor 210. Audited results can be part of the credentials of the expert and can made available in expert database. Project owner auditor 212 can audit the input provided by project owner, or methods of collection of data for NDE. Auditing ensures that quality data is provided to experts and experts provide quality inspection. Project owner auditor dashboard provides a summary of the audits of various project owners.

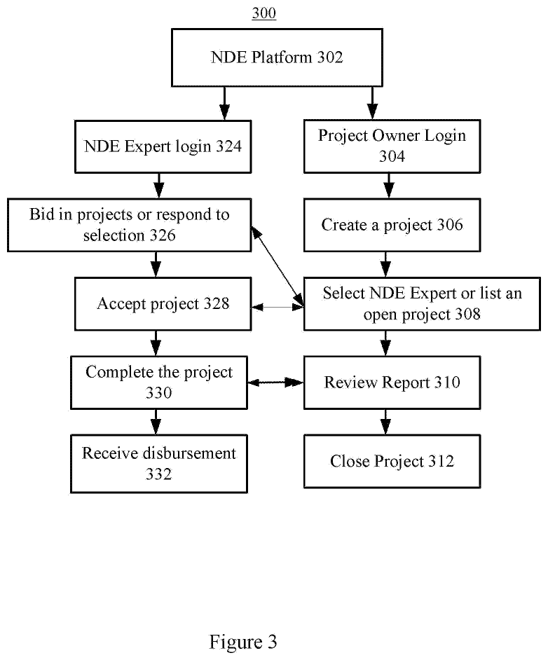

FIG. 3 describes a project workflow 300 for NDE as provided by the inspection module 115 in NDE platform 114. Project workflow starts with project owner logging into NDE platform 302 and inspection module 115 as in step 304 with appropriate user credentials. In the described embodiments, NDE platform 114 and NDE platform 302 can be the same.

Project owner creates a project in the platform as in 306. Creating a project comprises of describing the project and uploading all necessary documents. Project details includes project name, industry, description of the project, inspection methods, object dimensions, and thresholds. Description of the project could be any non-destructive evaluations such as failure analysis in a certain part in a pipeline or listing the scope of the project. Inspection methods can be visual, radiographic, ultrasonic or any other non-destructive methods. The project owner defines the industry so as to select the appropriate consultants to work on. A timeframe for completing the project is also listed indicating the urgency of the job. All necessary files acquired using a plurality of NDE techniques are uploaded for execution of the project. Digital x-ray, and ultrasonic images are some of the most comments file types that are acquired for NDE. The project owner has the option of making the project public by making the details available to all experts or retain in a private state so that a select few can access the details.

The NDE platform 302 provides a database of experts to execute the project. The project owner can search through the entire database of experts along with their credentials, and recommendations. In some embodiments, the NDE platform 302 can suggest the experts for a project using artificial intelligence techniques.

Once an expert is selected, the platform alerts an expert or experts. In certain embodiments, the project is open for biding. In such cases, NDE platform 302, alerts relevant experts so that they can bid. The NDE platform 302 establishes a secure communication channel such as 112 with the selected expert and tracks the working session.

Experts' login to NDE platform 302 as indicated in step 324. The expert can view available jobs or bid on open jobs from step 308 as shown in step 326. The expert can review the job description and accept the job in 328. The NDE platform 302 establishes a secure communication channel such as 112 upon accepting the project. Upon completing the project 330, the expert uploads the analysis or inspection report. NDE platform 302 informs the project owner of a completed job. The project owner reviews the inspection report 310 and closes the project as in step 312. NDE platform 302 will then disburse payments to experts in 332.

Prior to logging in, an expert profile is created in NDE platform 302. Creating a profile comprises of creating an account, listing education, level of expertise, domain experience, years of experience, service cost, ranking and recommendations from project owners, credentials, and expiry dates from trade schools, and NDE platform 302 training. In certain embodiments, NDE platform 302 verifies the credentials. In some embodiments, audit module 117, compares the performance of the experts against industry standards and ranks the experts. The experts are listed in the NDE database once the profile is complete and/or verified. In some embodiments, performance, ranking, and recommendations are evaluated from time to time and the profile is updated.

Expert dashboard provided by user interface 214 on NDE platform 302 enables the experts to manage multiple projects. Project owner dashboard provided by user interface 214 help in creating and managing project, select experts, review evaluation results and close the projects.

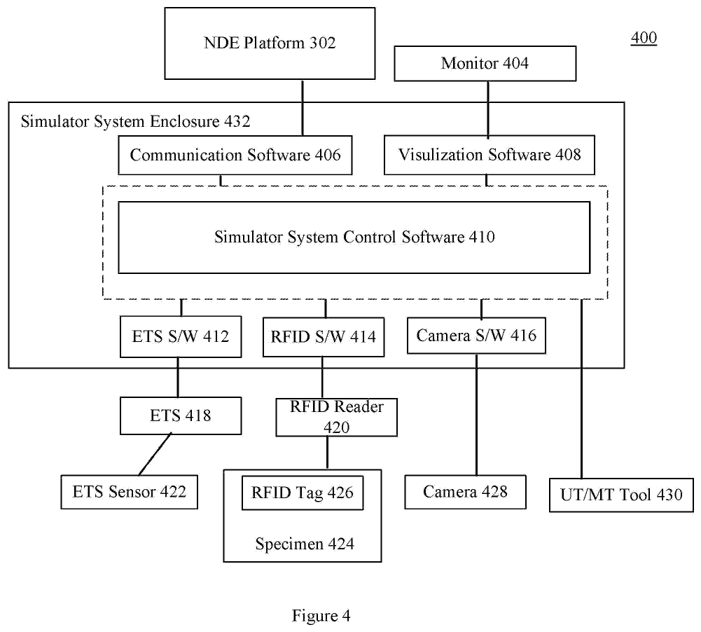

FIG. 4 describes the simulator 400 for training NDE experts. Training sessions can be set up through the NDE system 100 to replicate various types of flaws, materials, locations, and shapes in a close to real world environment. Users will be able to train on or refresh their flaw detection skills.

Various technologies such as electromagnetic tracking system(s), probes, cameras, and RFID technology enable simulator 400 or Training module 116 to track user's interaction with the specimen with a high degree of accuracy in three-dimensional space. Specimen refers to a variety of physical items a user may connect to system 400 to perform a scan. The specimens can be of various sizes and shapes to allow users the ability to perform scans on different types of items.

Simulator System 400 consists of various technologies (hardware and software) which provide users a real world like experience. Available pool of experts is qualified by Training 114. Simulator 400 comprises on Simulator System Enclosure (SSE) 432, Electromagnetic Tracking System (ETS) 418, camera 428, RFID reader 420, Ultrasonic Testing/Magnetic Testing (UT/MT) tools 430. SSE 432 is integrated with NDE platform 302. Simulator system control software 410 co-ordinates connecting and interacting with scanning probes, scanning specimens, transmitting scanned data, facilitate reviewing scanned data and evaluation analysis.

Simulator System 400 is mostly contained in a light weight and portable enclosure, Simulator System Enclosure 432. SSE 432 contains and protects many of the components including electromagnetic tracking system (system electronics unit and source), RFID reader, camera(s), computer for running software and connecting to NDE Platform 302, and power supply for components. In some embodiments, ETS 418 and RFID reader 420 reside outside the enclosure. SSE 432 provides connection and mounting points for other components such as monitor(s)/keyboard/mouse/microphone/camera, external computers, network, sensors, probes, specimens.

ETS sensor 422, cameras 428, RFID reader 420 are the input devices to the simulator. They are connected to SSCS 410 via respective software, ETS S/W 412, RFID S/W 414 and camera S/W 416. SSE 432 collects and interprets data from ETS sensor 422, cameras 428, RFID S/W 414, reads the specification of the specimen in the RFID tag attached to specimen 424 via RFID reader 420. Results can be viewed on the simulator system or on a separate computer. SSE 432 includes a host computer (not shown in the figure). NDE platform hosts a database of flaws. Communication software 406 connects the SSCS to NDE platform 302 to provides the capability to select a flaw for simulation.

Electromagnetic Tracking System (ETS) 418 provides flaw tracking of 6 degrees of freedom with a high degree of accuracy. ETS 418 generates electromagnetic pulses, sensor 422 transmits the pulses to specimen and receives signals from the specimen indicating location of the sensor thereby tracking movement and/or determine location of various components in order for simulation of the various NDE methods. ETS S/W 412 represents software necessary to generate and sense magnetic fields, compute position and orientation and interface with the host computer via RS232 or USB interface. In certain embodiments, ETS 418 can reside on SSE 432. In some embodiments, ETS sensor 422 is connected to a probe or camera. SSCS 410 provides software for tracking probe connected to ETS sensor 422 in 3d space with 6 degrees of freedom. Location of the sensor is there by computed based on the position of the probe.

Camera 428 refers to any digital camera such as regular digital cameras, AR/VR headsets, IR cameras or any type of camera that can produce a video feed. Camera 428 help in determining location/distance/orientation of a specimen, collaboration with NDE professionals or subject matter expert through NDE platform 402. Camera 428 help in capturing video to represent a user's visual inspection of the specimen for simulation of MT & PT.

UT/MT tool 430 comprise of real and dummy UT probes. Real probes are functioning probes providing another layer of data that is used to offer realistic experience. Real probes are connected to a pulser/receiver and the probe generates ultrasonic energy. SSCS 410 interprets data generated by the real probe along with ETS sensor data. Dummy probes are not connected to the pulser/receiver and does not produce ultrasonic energy. Dummy probe work in co-ordination with camera 428 to provide experience field experience without ultrasonic energy.

RFID tags 426 are placed or attached to the selected specimen 424. Specimens 424 are connected to SSE 432 are read by RFID reader 420 to identify the selected specimen. Specimen 424 can be hollow or solid cylinders (pipes/tubes), cubes, spheres, or any other shape the user may choose.

A processor or computer (not shown in figure) connects components such as ETS 418, RFID reader 420, camera 428, monitor 404. The computer can execute software for collecting and interpreting data from the components, and for communicating with visualization software. The computer also provides connectivity to platform 402.

Integration of SSE 432 with NDE platform 302 enables tracking training sessions. Scanning methods, specimen selection, flaw types, location of flaws within the specimen, hours of training, and end results are all tracked for each training session. Such tracking can help in further refining training or grading training or qualifying experts.

The simulator system 400 allows for flaw data to be virtually placed anywhere in the specimen. System 400 provides the capability of interacting with close to real world specimens with real flaw data. Visualization software 408 helps in displaying real flaw data when probe is placed in correct location and orientation.

Simulator 400 provides NDE training for various test methods, specimen specifications, flaw types, and location of flaw within specimen. Testing methods can comprise of Ultrasonic Testing (UT), dye penetrant (PT), Magnetic Particle (MT) and Radiographic Testing (RT).

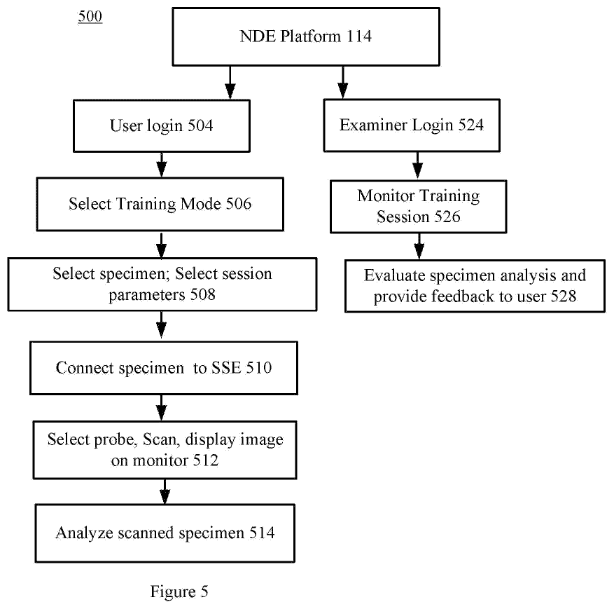

FIG. 5 shows a flowchart for user training as provided by NDE Platform 114. Workflow comprises of hardware setup and training sessions. Hardware setup comprises of connecting SSE 432 to NDE platform 114. User training starts with user logging into NDE platform 302 in step 504. Trainee selects training mode 506 from the trainee dashboard. The user then selects specimen and connects to SSE 432. RFID reader 420 identifies the specimen by reading the RFID tag 426 attached to the specimen 424. Other session parameters such as method, shape, material type, wall thickness, flaw type, and location are selected in 508.

In some embodiments, custom 3D printed specimens (with electronics) may be provided to the customer to practice on different shapes and geometries Appropriate visualization software is selected based on the scan type. Appropriate probes are used to scan based on the scan types.

Once the training session is initiated, the simulator downloads all data necessary for the training session from the platform. Specimen 424 is scanned with probes connected to sensors in 512. Simulator receives data from sensors 422, camera 428, NDE platform 302 and visualization software 408. Scanned images of the specimen are displayed on the monitor in 512. Location of the probe indicates the location of the sensor hence location within the specimen. Selected flaws and location of the flaws in a specimen are virtually introduced into a scanned image to create a modified scanned image by SSCS 410. Modified scanned image of the specimen is then analyzed for flaws in 514. Session data is stored on platform 114 for future review and the training session is closed.

NDE system 110 provide access to various utility software and a database of flaws for analysis. The database of flaws contains data from various type of scans, failures, locations and orientations which is used for training. User can compare against the database to determine the type of flaw. AR/VR based training is provided by training module 116 for users to train on equipment, standards/code and work instructions/procedures. AR/VR based tools assist users during data acquisition phase. AR/VR based tools provide easy interface to commercial quality management systems, thereby increasing the productivity, accuracy, and reliability of the data acquisition phase.

During a training session, an examiner can login to platform 114 with examiner credentials in 524. The examiner can then select a training session to monitor from the examiner dashboard provided by user interface 214 in 526. In 528, the examiner can follow each of the user steps and track progress and finally read the evaluation of the specimen and provide feedback to the user.

Steps 504-508 are executed for all type of scanning. Steps 510 and 512 depend on the type of scan. In case of UT, specimens can be scanned by running the UT probe 430 over the surface of the specimen in case of UT. Scan data is displayed on monitor 404 using visualization software 408 in real time.

Dye Penetrant testing (PT) is employed to detect surface flaws. A dye is applied on a specimen with cracks. The applied dye penetrates into cracks. Cameras are used for visual inspection of cracks. In a simulator, steps 510 and 512 comprises of connecting camera 428 to SSE 432. Image is displayed on monitor 404 using camera S/W 416.

Visualization software displays camera feed in real time overlaid with PT data. That is scanned image of the specimen is modified to virtually display PT scan. Camera position can be adjusted so that PT data is overlaid on camera feed. The camera feed and overlaid PT data are displayed on a monitor or an AR/VR headset.

In MT scan, a powder/dust is applied on a specimen. When magnetic pulses are applied, the powder/dust aligns in cracks so that the cracks are easily visible. In a simulator, for MT scan, steps 510 and 512 comprises of connecting camera 428 to SSE 432. Camera feed in real time with MT data overlaid is displayed on monitor 404. Camera position is adjusted so that MT data is overlaid on camera feed. The camera feed and overlaid MT data can be displayed on a monitor or an AR/VR headset.

For RT, steps 510 and 512 comprises of connecting ETS sensors 422 and camera 428. Camera 422 and ETS sensors 428 can be used to determine specimen orientation and location relative to sensors 428 representing x-ray tube. Digital x-ray file is displayed on monitor.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to particular examples disclosed, but that such claimed subject matter may also include all implementations falling within the scope of the appended claims, and equivalents thereof.

1. A method for enabling remotely located expert to perform non-destructive evaluation (NDE) comprising:
receiving project data from a project owner, the project data comprising digital data for non-destructive evaluation (NDE) acquired by non-destructive means;
providing to the project owner a selection of experts from a database of experts;
indicating availability of the project to an expert from the selection of experts;
providing project data to the expert;
establishing a secure communication between the expert and the project owner for exchange of information;
providing utility software to the expert for non-destructive evaluation;
receiving from the expert, non-destructive evaluation results of the project; and
transmitting non-destructive evaluation results of the project to the project owner via the secure communication channel.

2. The method of claim 1, wherein the experts are selected by artificial intelligence techniques based on any of qualification, experience, availability, and recommendations.

3. The method of claim 1, wherein the experts from the database of experts submit bids for the non-destructive evaluation of the project.

4. The method of claim 1, further comprising qualifying the expert, wherein the expert from the database of experts is evaluated before enrolling in the database.

5. The method of claim 1, wherein the expert from the database of experts is trained on a anyone of simulator or remote means.

6. The method of claim 1, wherein a performance of the expert is compared against a database of performance of other experts.

7. The method of claim 1, wherein the digital data comprises anyone of material type, thresholds for flaw, test type, description of an object for evaluation and image of the object.

8. The method of claim 1, wherein the evaluation results comprise anyone of flaws, thresholds exceeded, and annotated image data.

9. The method of claim 1, further comprising software developed through machine learning techniques provide assistance to the expert.

10. The method of claim 1, wherein artificial intelligence software is the expert.

11. The method of expert evaluation workflow comprising:
receiving by an expert, an alert about availability of a project for non-destructive evaluation (NDE) from a NDE platform;
receiving by the expert, project details in digital format;
sending by the expert, to the NDE platform accepting the project;
providing by the NDE platform, utility software for non-destructive evaluation of the project; and
receiving by the NDE platform, non-destructive evaluation results from the expert.

12. The method of claim 11, further comprising evaluating the expert before adding to a database in the NDE platform.

13. The method of claim 11, wherein the expert is trained on any one of a simulator or remote means.

14. A system comprising:
a first user device and a second user device configured to communicate with a cloud-based server, and
the first user device is configured to acquire digital information associated with an object for NDE;
wherein an inspection module running on the cloud-based server is configured to enable non-destructive inspection of the object utilizing the digital information,
wherein the first user device is configured to receive a report of the non-destructive inspection acquired by a second user device.

15. The system of claim 14, wherein a user of a second device is a qualified non-destructive evaluation expert.

16. The system of claim 14, wherein the inspection module further comprises software developed through machine learning techniques.

17. The system of claim 14, further comprising a training module, wherein the training module runs on the cloud-based server, configured to provide training for the non-destructive inspection.

18. The system of claim 17, the training module further comprises a simulator configured to provide hands-on training for the non-destructive inspection.

19. The system of claim 14, further comprising an audit module configured to facilitate monitoring of the non-destructive inspection.

20. The system of claim 14, further comprising an audit module configured to facilitate audit of the digital information.

21. A system for training NDE comprising:
a sensor configured to acquire digital data associated with a scan of a specimen;
control software for transmitting the digital data from the sensor to a display device;
communication software configured to select a flaw or simulation; and
visualization software configured to display the image data.

22. The system of claim 21, further comprising acquiring by the control software, a specification of the specimen based on a RFID tag connected to the specimen.

23. The system of claim 21, wherein the control software is further configured to virtually impose image of the flaw on the digital data.

24. The system of claim 23, wherein virtually imposing further comprises of positioning the flaw in random locations or randomly changing the nature of the flaw.

25. The system of claim 21, wherein the sensor can comprise any one of Electromagnetic Tracking System (ETS) sensor, camera, Ultrasonic sensor and Magnetic sensor.

26. The system of claim 21, wherein the sensor is connected to probe for scanning.

27. The system of claim 26, the control software is configured to compute position of the sensor by tracking motion of the probe in three-dimensional space with six-degrees of freedom.
